(19) United States
(12) Patent Application Publication
(10) Pub. No.: US 2004/0130796 A1
(43) Pub. Date: Jul. 8, 2004

(54) Support structure for optical devices

(76) Inventor: Nicholas Richard Coates, Cowborough (GB)

Correspondence Address: Iandiorio & Teska, 260 Bear Hill Road, Waltham, MA, 02451-1018, US

(21) Appl. No.: 10/474,083

(22) PCT Filed: Jan. 21, 2003
(86) PCT No.: PCT/GB03/00237

(30) Foreign Application Priority Data
Feb. 6, 2002 (GB) 0202762.1

(51) Int. Cl. G02B 27/14

(52) U.S. Cl. 359/630

(57) ABSTRACT

A support structure (2) for elements forming part of an optical device, which support structure (2) is made of a polymer foam material. The support structure. (2) is lightweight. The optical device may be a head mounted display or a head mounted projector.

This invention relates to a support structure for optical devices and, more especially, this invention relates to a support structure for elements forming part of an optical device.

Weight reduction in optical devices is important, especially in optical devices that are carried or worn by the user. An example of the importance of weight reduction in optical devices is in the design and manufacture of head mounted displays.

Optical devices such for example as head mounted displays require a total field of view which is 120°×60°. Known head mounted displays that have been designed to have a large field of view are very heavy and very expensive. In addition, the known head mounted displays are usually unbalanced with most of the weight being to the front of the head of a person wearing the head mounted display. The excessive weight of the known head mounted displays has made them uncomfortable and inefficient to use. More specifically, in order to work effectively, and eyepiece forming part of the head mounted displays must be in a fixed location relative to the eye of the user. The excessive weight of the head mounted display means that inertia created during use of the head mounted display is substantial, and tends to cause the head mounted display to lag when the user's head makes an angular acceleration, and to overshoot as the user's head decelerates. These problems are accentuated by the fact that it is difficult to attach head mounted displays to the user's head, as the flesh on the user's scalp is not firmly attached to their skull. Substantially the same problems are experienced with head mounted projectors.

It is an aim of the present invention to obviate or reduce the above mentioned problems.

Accordingly, in one nonlimiting embodiment of the present invention there is provided a support structure for elements forming part of an optical device, which support structure is made of a polymer foam material.

The support structure of the present invention may be lightweight and considerably lighter than known structures. This enables optical devices such for example as head mounted displays and head mounted projectors to be produced having a reduced weight compared with known optical devices. The reduced weight enables the optical devices to be produced having required dynamic characteristics, and to overcome the above mentioned problems of lagging when the user's head makes an angular acceleration, and to overshoot when the user's head decelerates.

The support structure of the present invention may be effective to produce optical devices such for example as head mounted displays and head mounted projectors having an overall weight of the order of 400 g. The centre of gravity in the fore and aft directions may be produced to be level with the user's ear, with the weight being kept as close to the user's head as possible in order to minimise the moment of inertia.

The support structure may b on in which the polymer foam material has fixing points for the elements forming part of the optical device.

The fixing points may be formed by machining the polymer foam material. Alternatively, the fixing points may be formed by moulding the polymer foam material. Any suitable and appropriate method of forming the fixing points can be used.

The support structure may be made in a plurality of parts, which parts are then secured together.

The parts may be secured together with an adhesive. Any suitable and appropriate adhesive may be employed. Alternatively, the parts may be secured together by inserts. Preferably, the inserts are made of a more dense material than the polymer foam material used to form the separate parts of the support structure.

The polymer foam material is preferably an extruded polystyrene foam, for example that sold as Styrofoam (registered trade mark). Other suitable and appropriate types of polymer foam material may be employed.

The support structure may be one in which the polymer foam material is encased by a thin plastics casing. The thin plastics casing may be made of any suitable and appropriate plastics material.

The support structure may include components which are mounted in or on a lightweight plastics material, and which are then fixed into the polymer foam material. This arrangement may be advantageous for optical devices such as head mounted displays which have head tracking devices fitted to them in order to detect the orientation of the user's head. Metal in close proximity to these had tracking devices can interfere with the correct operation of the head tracking devices. This particular construction may also give other advantages such for example as where two or more lenses require to be mounted as a unit.

Preferably, the lightweight plastics material is glass filled nylon. The glass filled nylon is approximately three times stiffer than unfilled nylon, and half the density of aluminium. Other lightweight plastics materials may be used.

The support structure may include the elements forming the optical device.

The elements forming the optical device may be optical elements. The elements may alternatively be optical elements and electronic elements.

The optical device may be a head mounted display or a head mounted projector. The optical device may be something other than a head mounted display or a head mounted projector if desired.

An embodiment of the invention will now be described solely by way of example and with reference to the accompanying drawings in which:

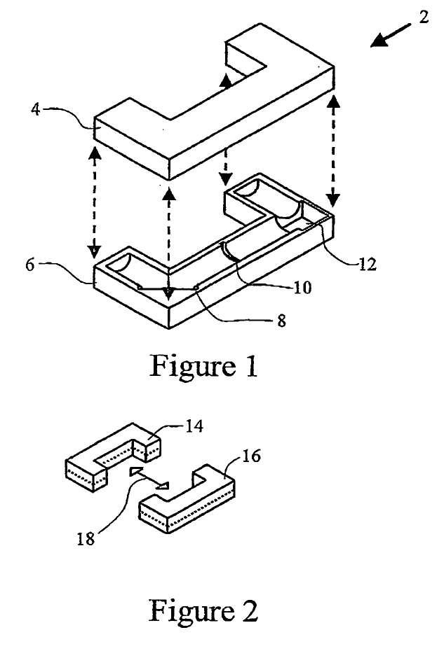

FIG. 1 shows two parts of a support structure being secured together; and

FIG. 2 shows two further parts of the support structure being secured together.

Referring to FIG. 1, there is shown part of a support structure 2 for elements (not shown) forming part of an optical device in the form of a head mounted display, The support structure 2 is made from a polymer foam material. The head mounted display may be both lightweight and have an optimum weight distribution in order to provide a comfortable head mounted display with a large field of view.

The support structure 2 shown in FIG. 1 comprises a top part 4 and a bottom part 6. The top and bottom parts 4, 6 are joined together in a vertical direction as shown by the broken arrows. The part 6 is shown with a slot 8, a groove 10 and a recess 12. The top part 4 may be similarly provided with a slot 8, a groove 10 and a recess 12. The slots, grooves and recesses 8, 10, 12 respectively are for accommodating the elements forming part of the optical device in the form of the head mounted display. The elements are optical elements and electronic elements.

The slots, grooves and recesses 8, 10, 12 respectively are machined from the polymer foam material using CNC machining techniques. These machining techniques allow for very accurate positioning of the elements in the support structure 2, These machine techniques also allow for small batch production of head mounted display devices, which are able to be made with the flexibility to modify them as required.

FIG. 2 shows a left part 14 and a right part 16 being joined together horizontally as shown by the double headed arrow 18. The parts 4, 6, 14, 16 are joined together by an adhesive material. The polymer foam material is an extruded polystyrene foam in the form of extruded Styrofoam (registered trade mark). The polymer foam material such for example as the polystyrene foam, may have a density of 36 kg/m³. This density is about 1/30^{th} of the density of non-foamed polymer materials.

The material performance index of the polymer foam material may be given by the equation:

M=E^{1/3}/r

where M is the material performance index, E is Young's modulus of stiffness, and r is the density of any material except carbon fibre reinforced plastic.

Foamed polymers have the highest value of the material performance index, which applies to panel structures as opposed to ties or struts. As mentioned above, the CNC machining techniques can be used for small batch production of support structures, for example in the form of shells. If mass production of the support structure is required, then the polymer foam material can be moulded. With moulding, consideration may be given to any shrinkage or distortion that may occur during me moulding process.

It is to be appreciated that the embodiment of the invention described above with reference to the accompanying drawings has been given by way of example only and that modifications may be effected. Thus, for example, a polymer foam material other than the Styrofoam may be used. The parts of the support structure 2 may be in shapes different to the illustrated parts 4, 6, 14, 16.

1. A support structure for elements forming part of an optical device, which support structure is made of a polymer foam material.

2. A support structure according to claim 1 in which the polymer foam material has fixing points for the elements forming part of the optical device.

3. A structure according to claim 2 in which the fixing points are formed by machining the polymer foam material.

4. A support structure according to claim 2 in which the fixing points are formed by moulding the polymer foam material.

5. A support structure according to any one of the preceding claims and which is made in a plurality of parts, which parts are then secured together.

6. A support structure according to claim 5 in which the parts are secured together with an adhesive.

7. A support structure according to claim 5 in which the parts are secured together by inserts.

8. A support structure according to claim 7 in which the inserts are made of a more dense material than the polymer material used to form the separate parts of the head mounted support structure.

9. A support structure according to any one of the preceding claims in which the polymer foam material is Styrofoam.

10. A support structure according to any one of the preceding claims in which the polymer foam material is encased by a thin plastics casing.

11. A support structure according to any one of the preceding claims and including metal components which are mounted in or on a lightweight plastics material, and which are then fixed into the polymer foam material.

12. A support structure according to claim 11 in which the lightweight plastics material is glass filled nylon.

13. A support structure according to any one of the preceding claims and including the elements forming the optical device.

14. A support structure according to claim 13 in which the elements are optical elements.

15. A support structure according to claim 13 in which the elements are optical elements and electronic elements.

16. A support structure according to any one of claims 13-15 in which the optical device is a head mounted display.

17. A support structure according to any one of claims 13-15 in which the optical device is a head mounted projector.
